(19) United States
(12) Patent Application Publication
(10) Pub. No.: US 2025/0246920 A1
(43) Pub. Date: Jul. 31, 2025

(54) Smart Device Charging Tower and Usage Limiter Device

(71) Applicant: Marlon Reynolds, St. Paul, MN (US)

(72) Inventor: Marlon Reynolds, St. Paul, MN (US)

(21) Appl. No.: 19/021,442

(22) Filed: Jan. 15, 2025

Related U.S. Application Data
(60) Provisional application No. 63/626,601, filed on Jan. 30, 2024.

(51) Int. Cl. H02J 7/00; G08B 3/10

(52) U.S. Cl. CPC H02J 7/0042; G08B 3/10; H02J 7/0048

(57) ABSTRACT

A smart device charging tower and usage limiter device is provided. The device is designed to provide parents with an effective means of monitoring and controlling children's access to electronic smart devices by restricting use during specified times. The device comprises a body made comprised of a plurality of grounded electrical outlets and multiple charging ports. The device includes memory to track the power status of smart devices connected to the outlets and/or charging ports, emitting an audible alarm via an integrated speaker when unauthorized tampering or unplugging is detected. The alarm and security settings are configured using a digital keypad, allowing users to input the time, set access periods, and arm or disarm the system using passcodes. A remote fob also allows for wireless control for arming, disarming, and reactivating the device.

### CROSS-REFERENCE TO RELATED APPLICATION

The present application claims priority to, and the benefit of, U.S. Provisional Application No. 63/626,601, which was filed on Jan. 30, 2024, and is incorporated herein by reference in its entirety.

### FIELD OF THE INVENTION

The present invention relates generally to the field of smart device monitoring. More specifically, the present invention relates to a smart device charging tower and usage limiter device designed to help parents monitor and control children's access to smart devices by restricting usage to the smart devices while they are attached to the device. Accordingly, the present disclosure makes specific reference thereto. Nonetheless, it is to be appreciated that aspects of the present invention are also equally applicable to other like applications, devices, and methods of manufacture.

### BACKGROUND

In recent years, the widespread availability of smartphones, tablets, and other smart devices has significantly changed the routines and lifestyles of children. These devices, while offering educational and entertainment benefits, often result in prolonged screen time that can negatively affect sleep patterns, emotional health, and academic performance. Many parents struggle to monitor or limit their children's usage, particularly during bedtime or other important periods for rest. Children may access their devices without parental consent, especially at night when supervision is limited, exacerbating issues related to sleep deprivation and over-stimulation. This can lead to negative effects on cognitive functioning, concentration, and overall mental well-being. Efforts to curb this problem using traditional methods, such as verbal rules or basic timers, are often ineffective or easily circumvented by tech-savvy children. Furthermore, parents face challenges in securing devices while also ensuring they remain charged and ready for legitimate use. Therefore, a comprehensive solution is needed to simultaneously regulate access to these smart devices and maintain their functionality through secure charging and tamper-proof monitoring systems.

Therefore, there exists a long-felt need in the art for a smart device charging tower and usage limiter device that prevents unauthorized access to electronic devices during designated periods. There also exists a long-felt need in the art for a smart device charging tower and usage limiter device that enables secure and convenient charging of multiple devices simultaneously while providing real-time feedback on usage status. Moreover, there exists a long-felt need in the art for a smart device charging tower and usage limiter device that alerts parents to potential tampering and includes remote-control capabilities for convenience and additional security.

The subject matter disclosed and claimed herein, in one embodiment thereof, comprises a smart device charging tower and usage limiter device. The device is designed to provide parents with an effective means of monitoring and controlling children's access to electronic smart devices by restricting use during specified times. The device comprises a body made comprised of a plurality of grounded electrical outlets and multiple charging ports. The device includes memory to track the power status of smart devices connected to the outlets and/or charging ports, emitting an audible alarm via an integrated speaker when unauthorized tampering or unplugging is detected. The alarm and security settings are configured using a digital keypad, allowing users to input the time, set access periods, and arm or disarm the system using passcodes. A remote fob also allows for wireless control for arming, disarming, and reactivating the device.

In this manner, the smart device charging tower and usage limiter device of the present invention accomplishes all the forgoing objectives and provides a device that restricts smart device access during unauthorized times while maintaining efficient charging functionality. More specifically, the digital keypad and memory-tracking system ensures that usage times are pre-configured and tamper events are logged and immediately addressed through an audible alarm. By combining monitoring, charging, and alarm features in a single system, the invention addresses parental concerns, providing a secure, tamper-proof, and user-friendly method to control smart device usage effectively.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a smart device charging tower and usage limiter device designed to monitor and control electronic smart device usage for parental control.

The device comprises a vertical tower-like body made from flame-retardant ABS plastic, with a weighted base and rubberized, non-slip feet for stability. The body includes at least one grounded electrical outlet, which may be rotatable to accommodate various plug types, and multiple charging ports, such as USB, for simultaneous smart device charging.

The body also features status lights that provide visual feedback on the operational state of each outlet and port, indicating whether they are inactive, armed and charging, or disarmed. A memory component tracks the charging status of connected devices. If tampering or unplugging is detected, an audible alarm is triggered via a built-in speaker. Security settings allow users to customize the alarm duration and system reset behavior.

A digital keypad on the body facilitates the configuration of time settings, alarm schedules, and security passcodes, with a lockout feature after multiple incorrect passcode attempts. The device also includes a remote fob with buttons for arming/disarming the device and reactivating it remotely, enhancing convenience when the device is placed in hard-to-reach locations.

The device can be powered either by a standard 110/120 v power cord or an internal rechargeable battery, with a battery status indicator showing the charge level.

During use, users connect smart devices to the charging ports and activate the security features via the keypad or remote fob. If a device is tampered with during restricted periods, the alarm sounds, and the corresponding port's indicator changes status. Disarming is achieved through the remote fob or passcode entry.

Accordingly, the smart device charging tower and usage limiter device of the present invention is particularly advantageous as it provides a device that restricts smart device access during unauthorized times while maintaining efficient charging functionality. More specifically, the digital keypad and memory-tracking system ensures that usage times are pre-configured and tamper events are logged and immediately addressed through an audible alarm. By combining monitoring, charging, and alarm features in a single system, the invention addresses parental concerns, providing a secure, tamper-proof, and user-friendly method to control smart device usage effectively.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a smart device charging tower and usage limiter device of the present invention in accordance with the disclosed architecture;

FIG. 2 illustrates a graphical view of security functions of one potential embodiment of a smart device charging tower and usage limiter device of the present invention in accordance with the disclosed architecture; and

FIG. 3 illustrates a flowchart of a method of using one potential embodiment of a smart device charging tower and usage limiter device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a smart device charging tower and usage limiter device that prevents unauthorized access to electronic devices during designated periods. There also exists a long-felt need in the art for a smart device charging tower and usage limiter device that enables secure and convenient charging of multiple devices simultaneously while providing real-time feedback on usage status. Moreover, there exists a long-felt need in the art for a smart device charging tower and usage limiter device that alerts parents to potential tampering and includes remote-control capabilities for convenience and additional security.

The present invention, in one exemplary embodiment, is comprised of a smart device charging tower and usage limiter device designed for parental control to monitor and regulate electronic smart device usage. The device includes a vertical, tower-shaped body made of flame-retardant ABS plastic, featuring a weighted base and rubberized, non-slip feet for stability. The body comprises at least one grounded electrical outlet, which may be rotatable for compatibility with various plug types, and multiple charging ports, such as USB, for simultaneous charging of smart devices.

Status lights on the body provide visual feedback, indicating whether outlets and ports are inactive, armed and charging, or disarmed. A memory component monitors the charging status of connected devices. If tampering or disconnection occurs, a built-in speaker emits an audible alarm. Security settings allow users to customize alarm duration and system reset functions.

A digital keypad on the body enables configuration of time settings, alarm schedules, and security passcodes, with a lockout feature activated after multiple incorrect passcode attempts. A remote fob with buttons for arming, disarming, and reactivating the device remotely enhances usability, especially when the device is positioned in hard-to-reach areas.

The device can be powered by a standard 110/120V power cord or an internal rechargeable battery, with a battery status indicator showing the charge level.

During use, users connect smart devices to the charging ports and activate security features via the keypad or remote fob. If tampering occurs during restricted periods, the alarm is triggered, and the corresponding port's indicator changes status. Disarming is achieved through passcode entry or the remote fob.

The smart device charging tower and usage limiter provides an effective solution for restricting smart device access during unauthorized periods while maintaining efficient charging. The digital keypad and memory-tracking system ensure pre-configured usage times and immediate responses to tampering through an audible alarm. By integrating monitoring, charging, and alarm functions, the device offers a secure, tamper-resistant, and user-friendly method for managing smart device usage.

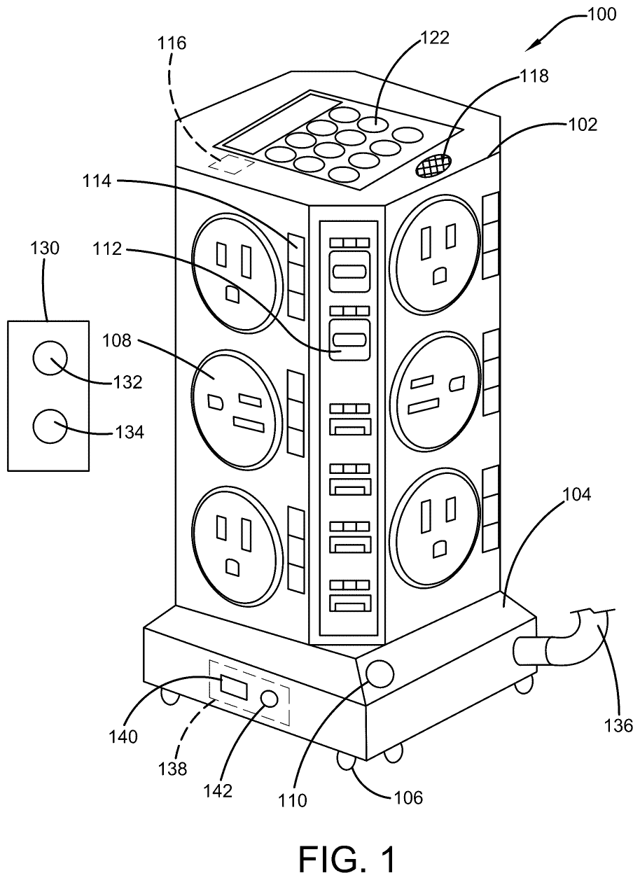

Referring initially to the drawings, FIG. 1 illustrates a perspective view of one potential embodiment of a smart device charging tower and usage limiter device 100 of the present invention in accordance with the disclosed architecture. The smart device charging tower and usage limiter device 100 is a multifunctional security charging device designed to help parents monitor and control the use of electronic smart devices by children, ensuring that such smart devices are only accessible during authorized times.

In the preferred embodiment, the device 100 is comprised of a tower-like body 102 that stands vertically. In other embodiments, the body 102 may lay flat horizontally. The body 102 may be any shape, such as but not limited to cylindrical, rectangular, or polygonal. The body 102 is preferably made from a flame-retardant ABS plastic. The base 104 of the body 102 is preferably weighted to improve stability and is further comprised of rubberized, non-slip feet 106 to prevent unintended tipping or sliding, as seen in FIG. 1.

The device 100 is comprised of at least one grounded electrical outlet 108 that may be configured to rotate in one embodiment, allowing users to adjust the orientation of the outlet 108 as needed to accommodate a variety of plug shapes and sizes, such as but not limited to 110/120 v outlets. A grounded light indicator 110 in the form of an LED provides a clear visual confirmation that the device 100 is properly grounded and safe for use. The device 100 also comprises a series of charging ports 112, such as but not limited to USB ports (of any USB type), enabling the simultaneous charging of smart devices, such as but not limited to smartphones, tablets, smartwatches, computers, and other compatible devices.

At least one light 114 located on the body 102 provides users with real-time feedback on the status of each charging port 112 and outlet 108. By way of example, a first color of the light 114 indicates that the port 112 and/or outlet 108 is disarmed and inactive. A second color of the light 114 indicates that the port 112 or outlet 108 is armed and actively monitoring and charging. A third color of the light 114 shows that the port 112 or outlet 108 is not armed and is only actively charging a connected smart device.

As noted, the device 100 is designed to monitor the status of connected smart devices actively. More specifically, a memory 116 tracks the charging state of each smart device connected to the charging port 112 and/or outlet 108. If a smart device ceases to draw power from the specific port 112 and/or outlet 108—indicating possible unplugging or tampering—the device 100 triggers an immediate security response via a speaker 118 that emits an audible alarm. The security functions 120 are designed not only to notify users of potential tampering but also to deter further unauthorized access by creating an immediate disruption.

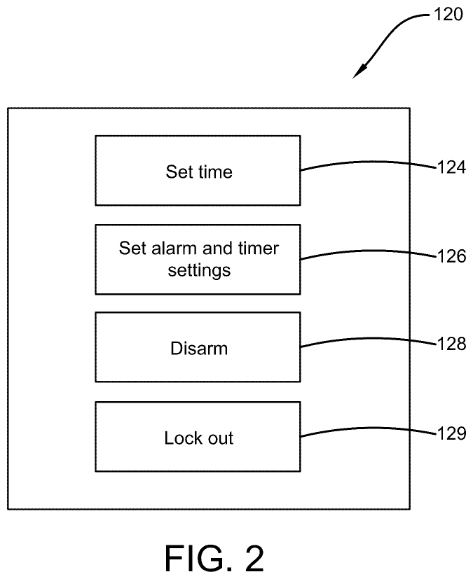

The security functions 120, as seen in FIG. 2, also allows users to configure the alarm duration and set whether the system will automatically reset after a specified period. For example, the user may configure the speaker 118 to emit an alarm for a customizable timer period before pausing, after which the device 100 may either reset to a fully armed state or remain disarmed until manually reactivated.

The device 100 is also comprised of a digital keypad 122 located on the body 102 that enables users to input settings and manage the security functions 120 of the device 100. More specifically, functions available through the keypad 122 include setting the current time 124, configuring alarm and timer settings 126 to specify periods during which smart device access is restricted, and disarming 128 the device 100 using a user-defined numerical and/or text passcode. The keypad 122 is preferably positioned on the upper portion of the body 102. The security functions 120 related to disarming 128 may also include a lockout feature 129, where multiple incorrect passcode attempts result in a temporary system lockdown to further prevent unauthorized tampering.

In one embodiment, the device 100 also includes at least one remote fob 130 designed for remote operation of the device 100. A first button 132 of the fob 130 enables the user to arm or disarm the device 100, activating or deactivating the security features 120 as needed. A second button 134 is a reactivation control that reactivates the device 100 in cases where the device 100 has been temporarily disabled. The security functions 120 accessible via the remote fob 130 are designed to provide convenience without compromising the security of the system. For example, if the device 100 is placed in an inaccessible area, such as a high shelf, the remote fob 130 allows the user to maintain full control over the alarm settings without requiring physical interaction with the device 100.

The device 100 operates using two power source options. More specifically, the device 100 can be connected via a standard 110/120 v male power cord 136 to an external power source for continuous operation. Alternatively, the device 100 can be powered by an internal, rechargeable battery 138, allowing for cordless operation when desired. In this embodiment, the battery 138 is comprised of a charging port 140, such as but not limited to a USB-C or DC charging interface. A battery status indicator light 142 informs users of the current charge level of the battery 138, providing a visual cue for when recharging is necessary.

By way of example, to use the device 100, parents can connect their children's electronic smart devices to the charging ports 112 of the device 100 and activate the security features 120 (to configure/activate the alarm 124) using the keypad 122. By pressing the arm button 132 on the remote fob 130, parents can also activate the security features 120 to configure/activate the alarm 124, ensuring that device access is restricted throughout the night. If a child attempts to unplug a device during the restricted period, the corresponding red indicator light 114 for that port switches off, and the built-in speaker 118 emits a loud alarm. In the morning, the parents can use the passcode on the digital keypad 122 or press the disarm button 132 on the remote fob 130 to deactivate the security system, allowing safe and controlled access to the smart devices.

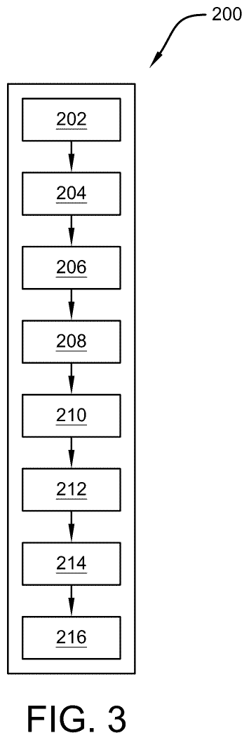

The present invention is also comprised of a method of using 200 the smart device charging tower and usage limiter device 100, as seen in FIG. 3. First, a smart device charging tower and usage limiter device 100 is provided, the device 100 being comprised of a body 102, at least one grounded electrical outlet 108, at least one charging port 112, a memory 116, a speaker 118, a digital keypad 122, and at least one remote fob 130 [Step 202]. Then, the current time 124 is configured using the keypad 122, and alarm settings 126 are programmed to specify authorized and restricted access times for smart device use [Step 204]. Smart devices such as smartphones, tablets, or smartwatches are then connected to the charging ports 112 and/or grounded outlets 108 [Step 210]. Once the smart devices are connected, the security functions 120 of the device 100 are activated by pressing the arm button 132 on the remote fob 130 or by entering a command via the keypad 122 [Step 212]. During the operation of the device 100, the memory 116 actively monitors the charging status of the connected smart devices. If a smart device is unplugged or tampered with during a restricted period, the speaker 118 emits an audible alarm in response. To disarm the device 100, the disarm button 132 on the remote fob 130 can be pressed, or the correct passcode can be entered on the keypad 122 [Step 214]. Finally, after the monitoring period is complete, the alarm system can be deactivated, and the connected smart devices can be safely disconnected from the charging ports 112 and/or outlets 108 [Step 216].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “smart device charging tower and usage limiter device” and “device” are interchangeable and refer to the smart device charging tower and usage limiter device 100 of the present invention.

Notwithstanding the forgoing, the smart device charging tower and usage limiter device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the smart device charging tower and usage limiter device 100 as shown in the FIGS. are for illustrative purposes only, and that many other sizes and shapes of the smart device charging tower and usage limiter device 100 are well within the scope of the present disclosure. Although the dimensions of the smart device charging tower and usage limiter device 100 are important design parameters for user convenience, the smart device charging tower and usage limiter device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A smart device charging tower and usage limiter device comprising:
a body comprised of a grounded electrical outlet and a charging port;
a memory configured to track a charging status of a smart device connected to the charging port or the grounded electrical outlet;
a speaker configured to emit an audible alarm in response to a detected change in the charging status during a restricted access period;
a digital keypad; and
a remote fob having a first button for arming or disarming the smart device charging tower and usage limiter device and a second button for reactivating the smart device charging tower and usage limiter device.

2. The smart device charging tower and usage limiter device of claim 1, wherein the body is made from a flame-retardant plastic.

3. The smart device charging tower and usage limiter device of claim 1, wherein the body is comprised of a weighted base.

4. The smart device charging tower and usage limiter device of claim 3, wherein the weight base is comprised of a non-slip foot.

5. The smart device charging tower and usage limiter device of claim 1, wherein the grounded electrical outlet rotates.

6. The smart device charging tower and usage limiter device of claim 1 further comprising a grounded light indicator that indicates whether the smart device charging tower and usage limiter device is grounded.

7. The smart device charging tower and usage limiter device of claim 1 further comprising a light.

8. The smart device charging tower and usage limiter device of claim 7, wherein the light displays a first color indicating an inactive status of the audible alarm.

9. The smart device charging tower and usage limiter device of claim 7, wherein the light displays a first color indicating an active status of the audible alarm.

10. The smart device charging tower and usage limiter device of claim 1 further comprising a power cord.

11. A smart device charging tower and usage limiter device comprising:
a body comprised of a grounded electrical outlet and a first charging port;
a memory configured to track a charging status of a smart device connected to the first charging port or the grounded electrical outlet;
a speaker configured to emit an audible alarm in response to a detected change in the charging status during a restricted access period;
a digital keypad;
a remote fob having a first button for arming or disarming the smart device charging tower and usage limiter device and a second button for reactivating the smart device charging tower and usage limiter device; and
a battery with a second charging port and a status indicator for displaying a charge level of the battery.

12. The smart device charging tower and usage limiter device of claim 11 further comprised of an indicator light that confirms the smart device charging tower and usage limiter device is grounded.

13. The smart device charging tower and usage limiter device of claim 11, wherein the battery is comprised of a rechargeable battery.

14. The smart device charging tower and usage limiter device of claim 11, wherein the audible alarm is emitted for a user-configurable duration.

15. The smart device charging tower and usage limiter device of claim 11 further comprised of a power cord.

16. The smart device charging tower and usage limiter device of claim 11 further comprising a light.

17. The smart device charging tower and usage limiter device of claim 16, wherein the light displays a first color indicating an active status of the audible alarm.

18. The smart device charging tower and usage limiter device of claim 11, wherein the first charging port is comprised of a USB port.

19. The smart device charging tower and usage limiter device of claim 11, wherein the body is comprised of a free-standing vertical body.

20. A method of using a smart device charging tower and usage limiter device, the method comprising the following steps:
providing a smart device charging and usage limiter device comprising a body, a grounded electrical outlet, a charging port, a memory, a speaker, a digital keypad, and a remote fob;
configuring an alarm setting using the digital keypad;
connecting a smart device to the charging port or the grounded electrical outlet;
activating a security functions; and
disarming the smart device charging and usage limiter device by pressing a disarm button on the remote fob or entering a passcode on the digital keypad.
